(19) United States
(12) Patent Application Publication
(10) Pub. No.: US 2007/0088717 A1
(43) Pub. Date: Apr. 19, 2007

(54) Back-tracking decision tree classifier for large reference data set

(75) Inventor: Ying Chen, San Jose, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/249,920

(22) Filed: Oct. 13, 2005

(51) Int. Cl. G06F 7/00

(52) U.S. Cl. 707/100

(57) ABSTRACT

Embodiments herein present a method for a back-tracking decision tree classifier for a large reference data set. The method analyzes first data files having a higher usage than second data files and identifies file attribute sets that are common in the first data files. Next, the method associates associated qualifiers with each of the file attribute sets, wherein each of the associated qualifiers represents a corresponding first data file. The associated qualifiers are then counted to determine the number of associated qualifiers that are associated with each of the file attribute sets. Subsequently, the file attribute sets are sorted in descending order based on the number of associated qualifiers. The counting and sorting are initially performed on file attribute sets that only have a single file attribute.

### BACKGROUND OF THE INVENTION

1. Field of the Invention

Embodiments herein present a method for a back-tracking decision tree classifier for a large reference data set.

2. Description of the Related Art

Within this application, several publications are referenced by arabic numerals within brackets. Full citations for these publications may be found at the end of the specification immediately preceding the claims. The disclosures of all these publications in their entireties are hereby expressly incorporated by reference into the present application for the purposes of indicating the background of the present invention and illustrating the state of the art.

Highly valuable files often exhibit unique sets of characteristics that differentiate themselves from other files. If such unique characteristics can be automatically extracted, it would empower the storage to predict what files are likely to be valuable early in their lifecycles, e.g., at the file creation time. Such a characterization problem is inherently similar to the well-known clustering problem, which deals with determining the intrinsic grouping of data, such as identifying customer grouping for different buying behaviors in marketing, pattern recognition in image processing, and plant and animal classification in biology. K-means [12] and hierarchical [11] are two classic examples of such algorithms. Recent advances in the algorithm development have incorporated techniques such as simulated annealing and genetic algorithms to address speed and algorithm robustness issues [4, 8]. Techniques developed by the machine learning and AI community such as neural network and decision tree [5, 14] are also emerging to facilitate tasks such as automatic file classifications [13]. Despite the similarity, such algorithms are not directly applicable to the problem addressed by embodiments of the invention due to its requirements and characteristics, as described more fully below.

Data mining intends to find association rules between items in large databases (called data warehouse). Many data mining algorithms have been developed over the last decades, such as well-known methods as detailed in [1, 2]. Finding association rules in large data warehouses are inherently more complicated than the problem addressed by embodiments of the invention. There is no prior knowledge of which item sets are going to be associated with which other item sets. The problem addressed by embodiments of the invention is not as complex, so is the solution. The task is to find what unique file attribute-value pair combination sets are associated with the high value file group.

Data classification helps users to distinguish high value files from others and then guide appropriate optimizations for difference classes of files, such as data migration, protection, and performance. Since information usage patterns and values change over time, the information classification are done periodically, such as quarterly or semi-annually, to take into account the changes over time. Given such system conditions, the classification method must fulfill several key requirements.

First, the classification method must be efficient. Although the classification can be done in background or utilizing long idle periods, e.g., overnight, taking more than a day or two to arrive at results may harm the normal system function.

Second, the classification method must be able to handle large number of attributes, large number of attribute-value pairs, and large number of combinations of them. Often file attributes include ownership (user/group), mode access bits, file names, directory structures, age, file types, etc. Each attribute can have many different values. Each file is defined by its own set of file attribute-value pairs. Clearly, a large reference data set may contain a large number of attribute-value pair combinations, yet only a small subset of such attribute-value pair combinations will be common and unique to the high value file group at a given time. Selecting relevant attribute-value pair combinations efficiently is crucial to the effectiveness of the algorithm.

Third, the classification method must ensure reasonable classification accuracy. This means that false-positives and false-negatives must fall within some acceptable range. Otherwise, the classification may misguide optimization and penalize the overall system.

Fourth, the classification method must generate results that are easily interpretable. Machine learning algorithms such as neural networks [9] and randomized clustering algorithms such as Genetic Algorithms [3] do not provide any insights on how the attribute-value pairs are selected and why. Being able to interpret classification results allows users to validate the results and improve the classification over time.

### SUMMARY OF THE INVENTION

Embodiments herein present a method for a back-tracking decision tree classifier for a large reference data set. The method analyzes first data files having a higher usage than second data files and identifies file attribute sets that are common in the first data files. Next, the method associates associated qualifiers with each of the file attribute sets, wherein each of the associated qualifiers represents a corresponding first data file. The associated qualifiers are then counted to determine the number of associated qualifiers that are associated with each of the file attribute sets. Subsequently, the file attribute sets are sorted in descending order based on the number of associated qualifiers. The counting and sorting are initially performed on file attribute sets that only have a single file attribute.

Following this, the method builds a decision tree classifier by associating a file attribute set with each of a plurality of tree nodes. Next, a root tree node is selected from the plurality of tree nodes based on the file attribute set having the largest number of associated qualifiers. One or more subsequent tree nodes are also selected based on the file attribute sets having the next largest number of associated qualifiers, i.e., following the file attribute set having the largest number of associated qualifiers. In other words, the selection of tree nodes is based on the file attribute sets that are common in the first data files.

When selected tree node(s) violate a constraint, the selected tree node(s) may be removed from the decision tree classifier. Only the most recently selected tree node is removed at a time, i.e., the method does not back-track up multiple levels. Alternate tree node(s) are then selected based on the file attribute sets that are common in the first data files. The method defines constraints, including a first constraint that prevents classification of a second data file as a first data file; and a second constraint that prevents classification of a first data file as a second data file. Further, the method defines a third constraint that prevents classification of a data file having a quantity of file attributes that is greater than a predetermined amount as a first data file. The method also defines a fourth constraint that prevents classification of a data file having an associated file attribute set that is larger than a predetermined size as a first data file.

Thus, the method classifies files by dividing the first files into second files that have a usage above a predetermined value and third files that have a usage below the predetermined value. The method then identifies sets of attribute-value pair combinations for each of the first files, wherein the attribute-value pair combinations comprise inherent attributes and respective attribute values. Distinguishing attribute-value pair combinations that are associated only with the second files and are not associated with the third files are also identified. Next, a set of distinguishing attribute-value pair combinations are established, wherein the set of distinguishing attribute-value pair combinations has a maximum set size. This comprises selecting distinguishing attribute-value pair combinations that have the least amount of attributes over the distinguishing attribute-value pair combinations that have a greater amount of the attributes to maintain the set of the distinguishing attribute-value pair combinations within the maximum set size.

Following this, fourth files are selected as files in the second files that have first distinguishing attribute-value pairs that are in the set of distinguishing attribute-value pair combinations. The Fourth files also have a number of attributes less that a predetermined attribute maximum, wherein the selecting of the fourth files is limited so as to produce maximum false-positives and maximum false-negatives. The maximum set size, the predetermined attribute maximum, the maximum false-positives, and the maximum false-negatives are established by a user. The fourth files are identified as the most valuable files of the first files. The method further provides that the selecting of the fourth files may execute a decision tree with back-tracking and tree pruning to maintain the fourth files within the maximum false-positives and the maximum false-negatives.

Accordingly, the overall solution extracts unique attribute sets for a given file grouping by intelligently building a decision tree classifier. In particular, this classification method includes a space and time-efficient method that selects appropriate tree nodes by identifying and examining the most relevant classification attribute-value pair combinations instead of all possible combinations via dynamic counting and sorting of file counts for a small subset of attribute-value pair combinations. Further, a back-tracking with tree pruning method is provided that selects alternate tree nodes when the default selection method leads to constraint violations, e.g., the false-positive constraint. This leads to the overall decision-tree classifier which is efficient and applicable to a wide range of applications, such as automatic retention classification, automatic data management policy generation, etc.

These and other aspects of embodiments of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the embodiments of the invention without departing from the spirit thereof, and the invention includes all such modifications.

### BRIEF DESCRIPTION OF THE DRAWINGS

The embodiments of the invention will be better understood from the following detailed description with reference to the drawings, in which:

FIG. 1 is a diagram of a sample decision tree classifier according to a method of the invention;

FIG. 2 is a diagram of another sample decision tree classifier according to a method of the invention;

FIG. 3 is a diagram of another sample decision tree classifier according to a method of the invention; and

FIG. 4 is a flow diagram illustrating a method of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the invention.

Information Lifecycle Management (ILM) aims at dynamically classifying the voluminous reference information based on their values throughout their lifecycles to improve IT resource utilization automatically. Existing storage systems categorize data using usage patterns, ages, or combinations of them. Often recent and popularly used files are considered to have high value. Such classifications are useful to certain extends, however, they reveal little insights into information, e.g., why are the popular files popular? Embodiments of the invention capitalize on a keen observation that popular files often differentiate themselves through some unique sets of attributes, e.g., owners, file types, or the combinations of them, and presents a classification method that extracts such unique attribute sets automatically to distinguish the popular file group from others. Such classification ability empowers storage systems to predict group membership for a given file and perform a number of optimizations that were not possible before. For instance, if storage is able to determine if a file is going to be inactive based on the file attributes, the storage can place the file into appropriate storage device in storage tiers as soon as the file is created to avoid expensive data migration later on.

This classification method can be generalized to classify many other file groupings as long as those file groupings have the following three characteristics: First, the file groupings have significant group size differences. For example, typically the highly valuable (popular) file group is a very small fraction of the overall data set, e.g.,. Second, the key attributes that characterize the file group are often relatively simple. That is, only a small number of attribute sets with relatively simple attribute combinations are sufficient to characterize the high value file group. Third, the classification should cope with thresholds such as false-positives (low value files that are wrongly classified into high value group) and false-negatives (the reverse of the false-positives). For example, for reference data, users typically can tolerate a relatively high fraction of false-positives. This is because even if 5% of more files are wrongly classified as high value files (the reality may be 5%), the classifier is still more valuable than no classification at all. However, false-negative threshold may be low, since the cost of wrong classification for high value files is high.

The classification method utilizes such characteristics to ensure efficiency while meeting several constraints. It differs from other well-known algorithms such as clustering algorithms and data mining, which also are often used to determine the intrinsic grouping of data. Yet they either do not deal with constraints well or are too complicated and slow.

Accordingly, the overall solution extracts unique attribute sets for a given file grouping by intelligently building a decision tree classifier. In particular, this classification method includes a space and time-efficient method that selects appropriate tree nodes by identifying and examining the most relevant classification attribute-value pair combinations instead of all possible combinations via dynamic counting and sorting of file counts for a small subset of attribute-value pair combinations. Further, a back-tracking with tree pruning method is provided that selects alternate tree nodes when the default selection method leads to constraint violations, e.g., the false-positive constraint. This leads to the overall decision-tree classifier which is efficient and applicable to a wide range of applications, such as automatic retention classification, automatic data management policy generation, etc.

The following example is provided to formalize the classification problem: a file grouping derived based on a set of file attributes F, such as usage frequency and age. Two file groups C and NC are created based on F. C is the small file group containing high value files (i.e., the first data files). NC is the large file group that contains the rest of the files (less valuable, i.e., the second data files). The sum of C and NC is the total file set. C contains c % of the total files, and NC contains 1-c %. The classification algorithm can be easily extended to deal with more than two file groups. However, for ease of discussion two file groups are used as an example. Each file is defined by a set of inherent file attributes I and their respective values. The inherent attributes are intrinsic to files. They were associated with files when they are created. In typical Unix file systems, inherent file attributes include UID, GID, mode bits, file name, file types (maybe recognizable by file extensions), directory structure, file contents.

The problem of extracting unique characteristics that distinguishes C and NC is then to find at most N inherent attribute-value pair combinations S={S₁, S₂, . . . , Sₖ}, k≦N, that can be used to uniquely distinguish C from NC, subject to a set constraints. Here, S is the set of attribute-value pair combinations. The size of S is k. Sᵢ is an attribute-value pair combination that distinguishes C and NC. It can be the unique attribute-value pair combination that is common to C but not to NC, or the reverse. Sᵢ is further defined as follows: Sᵢ={Aᵢ₁, Aᵢ₂, . . . , Aᵢₘ}, m≦Z. Here, Aᵢₗ denotes an attribute-value pair ≦aᵢ₁, vᵢ₁> whose attribute is ail and its value is vᵢ₁. Sᵢ represents files that have the attribute-value pair combination as indicated by Aᵢ₁, Aᵢ₂, . . . , Aᵢₘ. That is, they all have attributes aᵢ₁, aᵢ₂, . . . , aᵢₘ whose values are vᵢ₁, vᵢ₂, . . . , and vᵢₘ respectively. Here, Sᵢ∩Sⱼ=\acute{ø}, i≠j. That is, the files that have the attribute-value pair combinations that belong to Sᵢ do not overlap with files that have the attribute-value pair combinations that belong to Sⱼ.

The problem has a set of constraints. First, the resulting false-positives fp must satisfy fp≦fpₘᵢₙ. Second, the resulting false-negative fn must satisfy fin≦fnₘᵢₙ. Third, the size of S, k, must satisfy k≦N. The algorithm of the embodiments of the invention will try to find a small sets of attribute-value pair combinations that distinguish C and NC. Fourth, the size m of each attribute-value pair combination Sᵢ must satisfy m≦Z. This is because the resulting attribute-value pair combinations that distinguish C and NC are typically remarkably simple. For instance, files from particular group of users are valuable simply because their projects have high business importance. Too specific or complicated a combination will not only make the results hard to be explained, but also increase the likelihood of wrong classification.

All above four constraints may be set by users or system by default. Too stringent constraints may not allow the algorithm to arrive at any results within a reasonable time frame. Too relaxed constraints may lead to wrong classifications which in turn guide wrong optimizations. Depending on the optimizations, typically, fp should probably not be more than 30% of the total reference data size. fn should not be more than 0.5% of the total, since the high value file population is already a small fraction of the total. The number of attribute-value pair combinations k should not be more than N=10, and the size of each attribute-value combinations m should not be more than Z=10. Overall, the problem is formalized into a constraint attribute-value extraction problem.

To extract unique characteristics of high value files, a decision tree classifier is built by utilizing a set of training data. If the classification is done on a quarterly basis, the system will track the file accesses and determine file grouping C and NC based on the file accesses in those 3 months. Such tracked information forms the training data for the classifier. Since C is normally a small fraction of the overall data set, it is likely that classification for C will be much faster than NC. Once a set of unique attribute sets is identified for C, all files that do not have those unique attribute-value pair combination sets will be classified into NC. NC may be classified first, or both C and NC at the same time, however, in common cases, given the large difference between the sizes of C and NC, classification of C is often much faster.

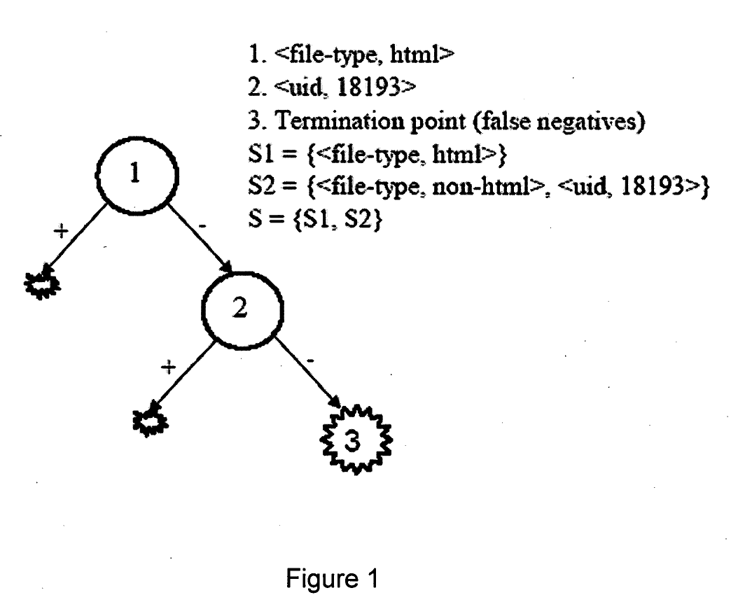

FIG. 1 shows a sample decision-tree classifier built using the algorithm of embodiments of the invention. Initially, a root tree node 1 is selected (based on the tree-node selection algorithm, as more fully described below). Each tree node designates one attribute-value pair combination that can potentially be used to characterize C. For instance, in the example, the root tree node 1 has attribute-value pair <file-type, html>. It indicates that html files is used from to distinguish C from NC . That is, all html files are considered to be of high value. Hence, S₁={<file-type, html>}. Once node 1 is selected, the algorithm discounts all html files from C and NC, and further characterizes the remaining non-html files in C if the number of the remaining files is larger than fnₘᵢₙ. In the example, the attribute-value pair <uid, 18193> is selected as the second level tree node 2. It indicates that all non-html files whose uid=18193 are considered to be of high value, i.e., they belong to C. It is denoted as S₂={<file-type, non-html>, <uid, 18193>}. In this example the classification terminates after selecting those two tree nodes, since all four constraints are met. That is, if all html files and all non-html files whose uids are 18193 discounted from C, the remaining number of files in C is smaller than the false-negative threshold, i.e., fn≦fnₘᵢₙ. The algorithm stops at the terminating node 3. All non-html files whose uids are not 18193 will be classified into NC. The final decision tree classifier is S={S₁, S2}.

In the decision tree, a left branch leading from any tree node always signifies a potential attribute-value pair combination that can be used to classify C, hence the “+” sign. The right branch leading from a tree node indicates that additional attribute-value pairs are needed to further characterize C. The number of the left leaves determines the number of attribute-value combinations in the decision-tree classifier, i.e., k, and k≦N. An attribute-value pair combination Sᵢ can be easily constructed by following a left leaf, and combining the negative values of all its ancestors' attributes respectively, except for that leaf's direct parent. For the direct parent, the attribute-value pair combination itself is combined, instead of the negative values. In the example, to find the attribute-value pair combination for S₂, the ancestors of the second left leaf are followed. The negative value of the node 1, <file-type, non-html> is combined to form S₂={≦file-type, non-html>, <uid, 18193>}. The sum of the sizes of the attribute-value pair combinations at each tree node determines the largest size of the attribute-value pair combination m, and m≦Z. In the example, m=2, and k=2. The last right leaf node leading from a tree node signifies the termination of the algorithm. If the remaining number of files in C after being classified by all the non-leaf tree nodes is smaller than fin, ,the algorithm stops. That leaf node also represents false-negative files.

It is easy to show that selecting a set of attribute-value combinations with minimal N and Z while meeting the fp and fn constraints for large attribute-value set are fundamentally NP-hard. Only heuristics algorithms are possible to solve such problems, and in practice, no algorithm can guarantee a valid classification to be found. For example, two attributes, access mode bits and owner modes, have three possible values for each of them: read, write, executable, and group, user, and others respectively. There are total of 32768 possible attribute-value combinations. The classification method must quickly identify most relevant attribute-value pair combinations for a given file group C while still preserving all given constraints. Embodiments of the invention present such a method that efficiently builds a decision-tree classifier such as the one shown in FIG. 1 by intelligently selecting the decision tree nodes through examining only a small subset of attribute-value pair combinations.

An attribute-value pair combination as denoted by tn={<a₁, v₁>, <a₂, v₂>, . . . , <aₘ, vₘ>}, where m≦Z. is considered as a qualified tree node if it meets two conditions. First, q>qₘᵢₙ, where q is the number of files that have that attribute-value pair combination as indicated by tn in C (called the qualifiers for tn), and qₘᵢₙ is the minimal number of files in C that must have the that attribute-value pair combination. Second, by selecting tn as a tree node, the classification up to that point should not violate the N, Z, or fpₘᵢₙ constraints. If either condition is not met, tn is not a qualified tree node.

To select the most relevant tree node for classification, the algorithm counts and sorts the qualifiers for the single attribute-value pair combinations (m=1) first, and uses them to try to classify C. If the final decision tree classifier for C cannot be built completely, the algorithm then considers attribute-value pair combinations that have two unique attribute-value pairs, and then three, four, etc., in that order. The combination that have largest qualifiers is considered first as a potential candidate for the qualified tree node since intuitively, this selection choice based on sorted qualifiers is made because the larger the number of qualifiers for a given attribute-value pair combination, the more strongly associated of that combination is to file group C . The algorithm tries out the attribute-value pair combinations that have small sizes first is that typical classifications for C will be simple. This tree node selection method is space and time efficient. In most cases, qualifiers for single attribute-value pair combinations only need to be counted. In many cases, a system with large enough memory such as 1 or 2 GBs will be sufficient for the algorithm to build in-memory hash structure to hold the qualifier counts, and perform in-memory sorting. Additional optimizations can be done to further divide attribute value ranges for a number of attributes. For instance, the file age value ranges can be divided into 1 year, 2-3 years, and 4-5 years and above 5 years. Then, there will be only four value ranges associated the age attribute. The number of attribute-value pairs can be further reduced. If qualifiers for attribute-value pair combinations with size larger than 1 must be counted, the space requirement for keeping the counts will increase significantly. The algorithm may be much slower if counting or sorting is done in-memory. However, in such cases, it is still better to count small size combinations than otherwise.

The overall tree node selection algorithm works as follows:
1. Let C_{file set}=C, NC_{file set}=NC, fp=0, m=1, k=0, size=0, maxiter=MAXITER, iter=0.
2. Scan all files in C_{file set}. For each unique attribute-value pair combination of size m, avᵢ={≦aᵢ₁, vᵢ₁>, <aᵢ₂, vᵢ₂>, . . . , <aᵢₘ, vᵢₘ>}, count its qualifiers, qᵢ. Here the size of an attribute-value pair combination is the number of attribute-value pairs in that combination.
3. Sort q's in decreasing order.
4. Repeat step 1 for NC_{file set}.
5. Select avⱼ whose qⱼ is the largest (based on the sorted results in step 3) and check if avⱼ is qualified based on the two conditioned as described above. To check if the fpₘᵢₙ constraint is met, let n be the number of files in NC_{file set} that have the same avⱼ. If n+fp>fpₘᵢₙ, it means that avⱼ is common NC_{file set}. So avⱼ is not qualified. To check if the N constraint is met, check if k+1>N. If so, avⱼ is disqualified. To check if the Z constraint is met, check if size+m>Z. If so, avⱼ is disqualified. Overall, if the fpₘᵢₙ constraint is violated, iter=iter+1 is set and then the attribute-value pair combination that has the next largest qualifiers q is selected and the same checks are repeated and if a qualified avy is found and iter≦maxiter, go to step 6. Otherwise, set m=m+1. If m≦Z, go to step 2 and repeat all steps from there. Otherwise, if either the Z or N constraints are not met, use the back-tracking algorithm as described later to select a qualified node av_{y}. If the back-tracking algorithm also fails to select an appropriate tree node, the algorithm stops with the fail-to-classify error.
6. Select avy as the tree node.
7. Set fp=fp+fp_{y}, where fp_{y} is the number of false-positives induced by this selecting avy as the tree node. It is also the number of files that have avy in NC_{file set}. It can be obtained based on the results from step 4.
8. Set size=xize+m, k=k+1.
9. Let C_{filesetavy} and NC_{filesetavy} be all the files in C_{fileset} and NC_{fileset} that have av_{y} respectively. Set C_{fileset}=C_{fileset}−C_{filesetavy} and NC_{filesetavy}=NC_{fileset}−NC_{filesetavy}.
10. Let f be the number of files in C_{file set}. If f≦fnₘᵢₙ, the algorithm terminates and a valid decision-tree classifier is obtained. Otherwise, go to step 2 and repeat all steps from there.

The default algorithm above is also controlled by an iteration parameter MAXITER. For each attribute-value combination size, the algorithm tries to pick tree-nodes from the largest MAXITER. If no qualified tree-node is found, the next larger combination size is tried. This is to prevent the algorithm from going into wrong classification directions completely. For instance, if it is true that C simply cannot be classified by single attribute-value pairs, there is no reason to try all of them before trying the combinations that have two unique attribute-value pairs. Furthermore, even from the level of association point of view, larger sized combinations may be more strongly associated with C than some of the single attribute-value pair combinations. If the sorted order of the single attribute-value pair combinations based on their qualifiers is as follows (in descending order): <a₁, v₁>, <a₂, v₂>, <a₃, v₃>, <a₁, v₁>, . . . then no attribute-value pair combinations with larger sizes can have qualifiers that are larger than the qualifiers for <a₁, v₁> or <a₂, v₂>, whose m=1. This is because the qualifiers for {<aᵢ, vᵢ>, <aⱼ, vⱼ>, . . . } (m>1) must be smaller than the qualifiers for individual <aᵢ, vᵢ>, <aⱼ, vⱼ> (m=1), etc. However, it is possible that the qualifiers for {<a₁, v₁>, <a₂, v₂>, . . . } (m=2) is larger than the qualifiers for <a₃, v₃> (m=1). Hence, it is possible that the two attribute-value pair combination may be more strongly associated with C than some single attribute-value pairs. For efficiency the algorithm by default does not try to count and sort larger attribute-value pair combinations. By controlling MAXITER the algorithm is allowed to shift to larger attribute-value pair combinations if the smaller ones do not work well.

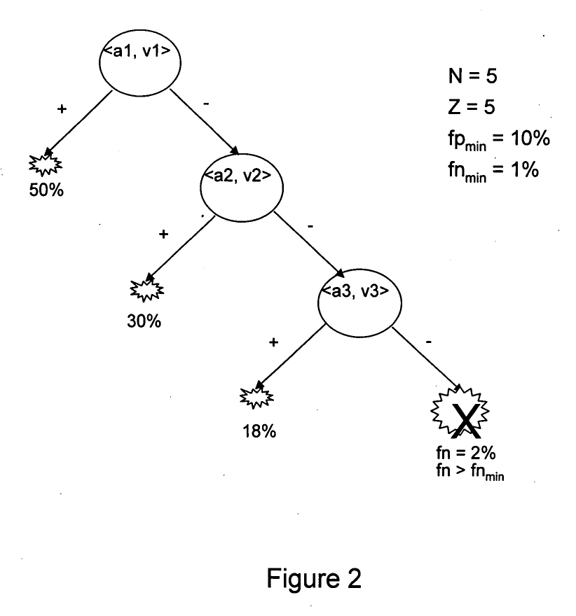

Under most cases, the above tree-node selection method works well to build a decision tree without violating any of the four constraints. However, in certain cases, the algorithm as is may not work. FIG. 2 shows such an example. The decision-tree classifier is built using default algorithm. The tree represents the following classification combinations: S={S₁, S₂, S₃}, S₁={<a₁, v₁>}, S₂={<a₁, v₁>, <a₂, v₂>}, and S3={<a₁, v₁>, <a₂, v₂>, <a₃, v₃>}. The tree indicated that the decision-tree at that point has classified 98% of the files in C. There are remaining 2% of the files that are not classifiable by any attribute-value pair combinations without violating one of the four constraints. In particular, fn=2%, and fn>fnₘᵢₙ. Hence the false-negative constraint is violated.

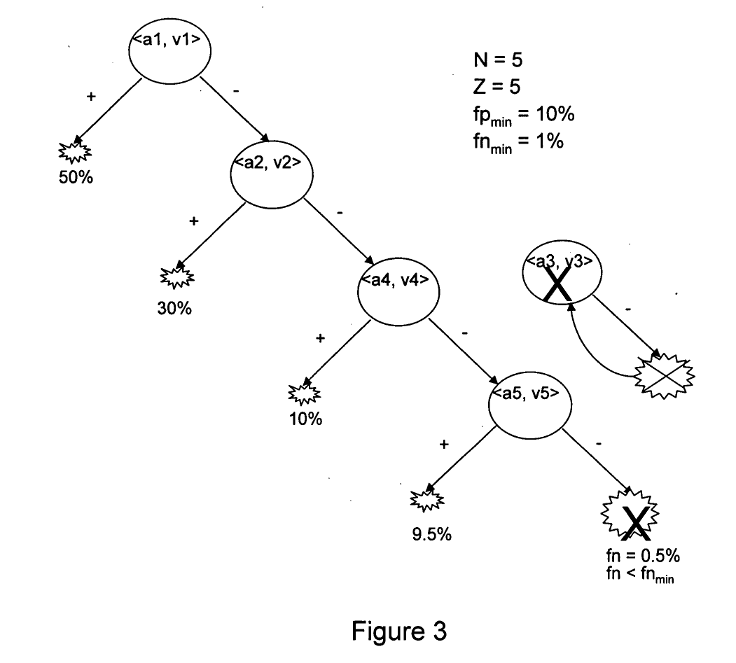

In such cases a back-tracking method is employed to select alternate attribute-value pair combinations that can lead to successful classifiers. Note that as in FIG. 2, by selecting <a₃, v₃>, the algorithm is led into a situation where no additional attribute-value pair combination selections can be meet the fnₘᵢₙ constraint. However, there may be many other qualified alternative attribute-value pairs that can be used to replace <a₃, v₃> and lead to a valid tree to as shown in FIG. 3. In this example, by back-tracking and replacing <a₃, v₃> with an alternative <a₄, v₄>, the algorithm is able to continue and build a valid decision tree without violating any of the four constraints.

Back-tracking can be combined with pruning to ensure that the N and Z constraints are met. For instance, in the example shown in FIG. 3, if N=3 rather than 5, the decision tree violates the N constraints. In such cases, the algorithm must backtrack to <a₄, v₄> and prune <a₅, v₅>. An alternative tree node such as {<a₇, v₇>, <a₈, v₈>} can be used to replace <a₄, v₄>. Such a node must meet the N constraint as well as the fnₘᵢₙ constraint. The method for selecting the alternative tree-nodes in the back-tracking and pruning phases are similar to the default tree-node selection algorithm except that it would skip the attribute-value pair combinations that are known to violate the constraints.

Therefore, embodiments herein present a method for a back-tracking decision tree classifier for a large reference data set. The method analyzes first data files having a higher usage than second data files and identifies file attribute sets that are common in the first data files. As discussed above, popular files often differentiate themselves through some unique sets of attributes, e.g., owners, file types, or the combinations of them. The method extracts such unique attribute sets automatically to distinguish the popular file group from others. Such classification ability empowers storage systems to predict group membership for a given file and perform a number of optimizations. Next, the method associates associated qualifiers with each of the file attribute sets, wherein each of the associated qualifiers represents a corresponding first data file. In the example above, q represents the qualifiers for the file attribute set tn, wherein q is the number of files that have that file attribute set as indicated by tn in C.

The method then counts associated qualifiers to determine the number of associated qualifiers that are associated with each of the file attribute sets. Subsequently, the file attribute sets are sorted in descending order based on the number of associated qualifiers. The counting and sorting are initially performed on file attribute sets that only have a single file attribute. In other words, the algorithm counts and sorts the qualifiers for the single attribute-value pair combinations (m=1) first, and uses them to try to classify C. If the final decision tree classifier for C cannot be built completely, the algorithm then considers attribute-value pair combinations that have two unique attribute-value pairs, and then three, four, etc., in that order. The algorithm tries out the attribute-value pair combinations that have small sizes first is that typical classifications for C will be simple. In most cases, qualifiers for single attribute-value pair combinations only need to be counted.

Following this, the method builds a decision tree classifier by associating a file attribute set with each of a plurality of tree nodes. A root tree node is selected from the plurality of tree nodes based on the file attribute set having the largest number of associated qualifiers. The combination that has largest qualifiers is considered first as a potential candidate for the qualified tree node since intuitively, this selection choice based on sorted qualifiers is made because the larger the number of qualifiers for a given file attribute set, the more strongly associated of that file attribute set is to file group C. One or more subsequent tree nodes are also selected based on the file attribute sets having the next largest number of associated qualifiers, i.e., following the file attribute set having the largest number of associated qualifiers. In other words, the selection of tree nodes is based on the file attribute sets that are common in the first data files. As described above, in the decision tree, a left branch leading from any tree node always signifies a potential attribute-value pair combination that can be used to classify C, hence the “+” sign. The right branch leading from a tree node indicates that additional attribute-value pairs are needed to further characterize C.

When selected tree node(s) violate a constraint, the selected tree node(s) may be removed from the decision tree classifier. For example, in FIG. 2, the tree indicates that the decision-tree has classified 98% of the files in C. There are remaining 2% of the files that are not classifiable by any attribute-value pair combinations without violating one of the four constraints. In particular, fn=2%, and fn>fnₘᵢₙ. Hence the false-negative constraint is violated. Only the most recently selected tree node is removed at a time, i.e., the method does not back-track up multiple levels. Alternate tree node(s) are then selected based on the file attribute sets that are common in the first data files. Note that as in FIG. 2, by selecting <a₃, v₃>, the algorithm is led into a situation where no additional attribute-value pair combination selections can be meet the fnₘᵢₙ constraint. However, there may be many other qualified alternative attribute-value pairs that can be used to replace <a₃, v₃> and lead to a valid tree to as shown in FIG. 3. In this example, by back-tracking and replacing <a₃, v₃> with an alternative <a₄, v₄>, the algorithm is able to continue and build a valid decision tree without violating any of the four constraints.

The method defines constraints, including a first constraint that prevents classification of a second data file as a first data file; and a second constraint that prevents classification of a first data file as a second data file. As discussed above, for reference data, users typically can tolerate a relatively high fraction of false-positives. This is because even if 5% of more files are wrongly classified as high value files (the reality may be 5%), the classifier is still more valuable than no classification at all. However, false-negative threshold may be low, since the cost of wrong classification for high value files is high.

Further, the method defines a third constraint that prevents classification of a data file having a quantity of file attributes that is greater than a predetermined amount as a first data file. As discussed more fully above, only a small number of attribute sets with relatively simple attribute combinations are sufficient to characterize the high value file group. The method also defines a fourth constraint that prevents classification of a data file having an associated file attribute set that is larger than a predetermined size as a first data file. This is because the resulting attribute-value pair combinations that distinguish C and NC are typically remarkably simple. For instance, files from particular group of users are valuable simply because their projects have high business importance. Too specific or complicated a combination will not only make the results hard to be explained, but also increase the likelihood of wrong classification.

Thus, the method classifies files by dividing the first files into second files that have a usage above a predetermined value and third files that have a usage below the predetermined value. In the example above, a file grouping derived based on a set of file attributes F, such as usage frequency and age. Two file groups C and NC are created based on F. C is the small file group, containing high value files. NC is the large file group that contains the rest of the files (less valuable). The method then identifies sets of attribute-value pair combinations for each of the first files, wherein the attribute-value pair combinations comprise inherent attributes and respective attribute values. In typical Unix file systems, inherent file attributes include UID, GID, mode bits, file name, file types (maybe recognizable by file extensions), directory structure, file contents.

Distinguishing attribute-value pair combinations that are associated only with the second files and are not associated with the third files are also identified. In the example above, the method finds at most N inherent attribute-value pair combinations S={S₁, S₂, . . . , Sₖ}, k≦N, that can be used to uniquely distinguish C from NC. Here, S is the set of attribute-value pair combinations. The size of S is k. Sᵢ is an attribute-value pair combination that distinguishes C and NC.

Next, a set of distinguishing attribute-value pair combinations are established, wherein the set of distinguishing attribute-value pair combinations has a maximum set size. In the example, the size of S, k, must satisfy k≦N. The algorithm of the embodiments of the invention will try to find a small sets of attribute-value pair combinations that distinguish C and NC. This comprises selecting distinguishing attribute-value pair combinations that have the least amount of attributes over the distinguishing attribute-value pair combinations that have a greater amount of the attributes to maintain the set of the distinguishing attribute-value pair combinations within the maximum set size.

Following this, fourth files are selected as files in the second files that have first distinguishing attribute-value pairs that are in the set of distinguishing attribute-value pair combinations. Again, in the example, the size m of each attribute-value pair combination sᵢ must satisfy m≦Z. The Fourth files also have a number of attributes less that a predetermined attribute maximum, wherein the selecting of the fourth files is limited so as to produce maximum false-positives and maximum false-negatives. In the example, the resulting false-positives fp must satisfy fp≦fpₘᵢₙ and the resulting false-negative fn must satisfy fn≦fnₘᵢₙ. The maximum set size, the predetermined attribute maximum, the. maximum false-positives, and the maximum false-negatives are established by a user. The fourth files are identified as the most valuable files of the first files. The method further provides that the selecting of the fourth files may execute a decision tree with back-tracking and tree pruning to maintain the fourth files within the maximum false-positives and the maximum false-negatives.

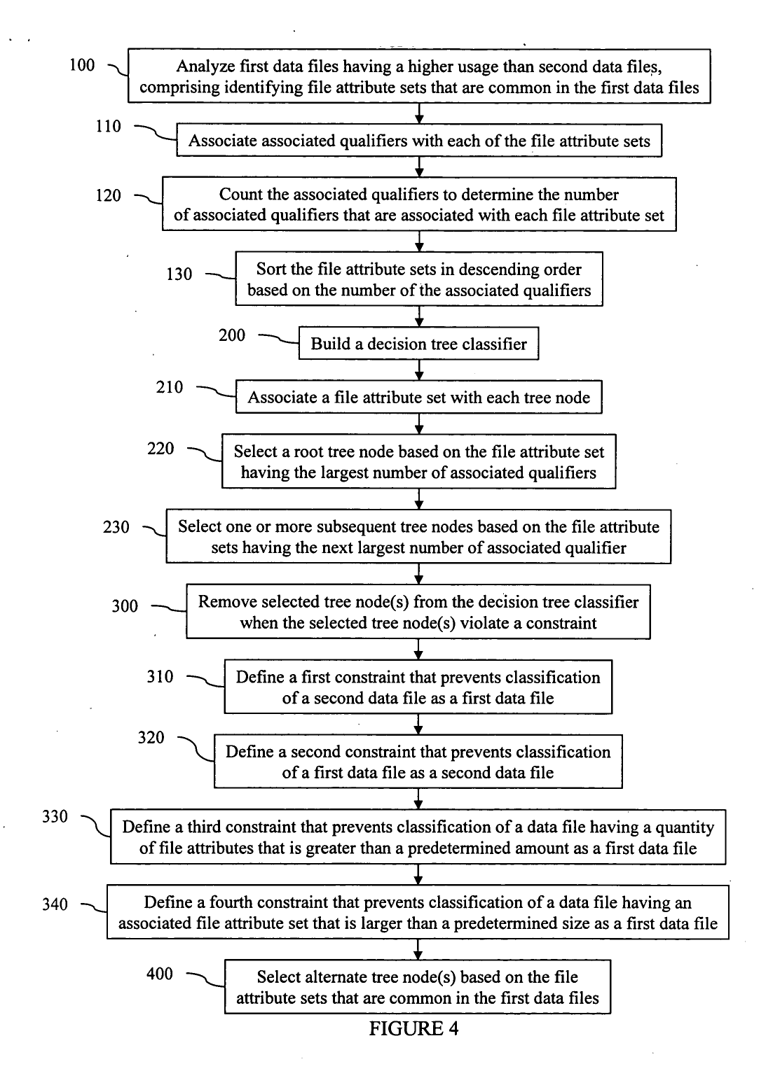

FIG. 4 illustrates a flow diagram of a method for a back-tracking decision tree classifier for a large reference data set. In item 100, the method begins by analyzing first data files having a higher usage than second data files, comprising identifying file attribute sets that are common in the first data files. Popular files often differentiate themselves through some unique sets of attributes, e.g., owners, file types, or the combinations of them. The method extracts such unique attribute sets automatically to distinguish the popular file group from others. This includes associating associated qualifiers with each of the file attribute sets, wherein each of the associated qualifiers represents a corresponding one of the first data files (item 110).

The associated qualifiers are then counted to determine the number of associated qualifiers that are associated with each file attribute set (item 120). Next, the file attribute sets are sorted in descending order based on the number of the associated qualifiers (item 130). The counting and the sorting is initially performed on the file attribute sets having only a single file attribute. The method counts and sorts the qualifiers for the single attribute-value pair combinations (m=1) first, and uses them to try to classify C. If the final decision tree classifier for C cannot be built completely, the algorithm then considers attribute-value pair combinations that have two unique attribute-value pairs, and then three, four, etc., in that order.

In item 200, the method builds a decision tree classifier, wherein a file attribute set is associated with each tree node (item 210). Further, a root tree node is selected based on the file attribute set having the largest number of associated qualifiers (item 220). The combination that has largest qualifiers is considered first as a potential candidate for the qualified tree node since intuitively, this selection choice based on sorted qualifiers is made because the larger the number of qualifiers for a given file attribute set, the more strongly associated of that file attribute set is to file group C. Then the files that have that file attribute set are removed from the first data files, and the remaining files in the first data files are counted and sorted again based on the associated qualifiers. One or more subsequent tree nodes are also selected based on the file attribute sets having the next largest number of associated qualifiers (item 230), i.e., following the file attribute set having the largest number of associated qualifiers. In other words, the selection of tree nodes is based on the file attribute sets that are common in the first data files, and the largest qualifier is selected to be the next level of tree node. The process repeats until the entire tree is built.

In item 300, selected tree node(s) are removed from the decision tree classifier when the selected tree node(s) violate a constraint. Only the most recently selected tree node is removed at a time, i.e., the method does not back-track up multiple levels. The method defines constraints, including defining a first constraint that prevents classification of a second data file as a first data file (item 310); and defining a second constraint that prevents classification of a first data file as a second data file (item 320). For reference data, users typically can tolerate a relatively high fraction of false-positives. This is because even if 5% of more files are wrongly classified as high value files (the reality may be 5%), the classifier is still more valuable than no classification at all. However, false-negative threshold may be low, since the cost of wrong classification for high value files is high.

Further, the method defines a third constraint that prevents classification of a data file having a quantity of file attributes that is greater than a predetermined amount as a first data file (item 330). Only a small number of attribute sets with relatively simple attribute combinations are sufficient to characterize the high value file group. The method also defines a fourth constraint that prevents classification of a data file having an associated file attribute set that is larger than a predetermined size as a first data file (340). Too specific or complicated a combination will not only make the results hard to be explained, but also increase the likelihood of wrong classification. Alternate tree node(s) are then selected based on the file attribute sets that are common in the first data files (item 400).

Accordingly, the overall solution extracts unique attribute sets for a given file grouping by intelligently building a decision tree classifier. In particular, this classification method includes a space and time-efficient method that selects appropriate tree nodes by identifying and examining the most relevant classification attribute-value pair combinations instead of all possible combinations via dynamic counting and sorting of file counts for a small subset of attribute-value pair combinations. Further, a back-tracking with tree pruning method is provided that selects alternate tree nodes when the default selection method leads to constraint violations, e.g., the false-positive constraint. This leads to the overall decision-tree classifier which is efficient and applicable to a wide range of applications, such as automatic retention classification, automatic data management policy generation, etc.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

What is claimed is:

1. A method for classifying data, comprising:
analyzing first data files having a higher usage than second data files, comprising identifying file attribute sets that are common in said first data files;
building a decision tree classifier, comprising selecting a root tree node from a plurality of tree nodes and selecting one or more subsequent tree nodes from said plurality of tree nodes, wherein said selecting of said root tree node and said selecting of said one or more subsequent tree nodes are based on said file attribute sets that are common in said first data files; and
removing a selected tree node from said decision tree classifier and selecting an alternate tree node based on said file attribute sets that are common in said first data files when said selected tree node violates a constraint.

2. The method according to claim 1, wherein said analyzing said first data files further comprises associating associated qualifiers with each of said file attribute sets, wherein each of said associated qualifiers represents a corresponding one of said first data files.

3. The method according to claim 2, wherein said analyzing said first data files further comprises counting said associated qualifiers to determine a number of said associated qualifiers that are associated with each of said file attribute sets.

4. The method according to claim 3, wherein said analyzing said first data files further comprises sorting said file attribute sets in descending order based on said number of said associated qualifiers.

5. The method according to claim 4, wherein said counting and said sorting is initially performed on said file attribute sets having only a single file attribute.

6. The method according to claim 4, wherein said building of said decision tree classifier further comprises associating one of said file attribute sets with each of said plurality of tree nodes.

7. The method according to claim 6, wherein said selecting of said root tree node comprises selecting a tree node associated with a file attribute set having a largest number of said associated qualifiers.

8. The method according to claim 7, wherein said selecting of said at least one subsequent tree nodes comprises selecting one or more of said tree nodes associated with file attribute sets having a next largest number of said associated qualifiers following said file attribute set having said largest number of said associated qualifiers.

9. The method according to claim 1, further comprising defining at least one said constraint, comprising at least one of:
defining a first constraint that prevents classification of at least one of said second data files as at least one of said first data files;
defining a second constraint that prevents classification of at least one of said first data files as at least one of said second data files;
defining a third constraint that prevents classification of a data file having a quantity of file attributes that is greater than a predetermined amount as one of said first data files; and
defining a fourth constraint that prevents classification of a data file having an associated file attribute set having a size that is greater than a predetermined size as one of said first data files.

10. The method according to claim 1, wherein said removing said selected tree node comprises only removing a most recently selected tree node.

11. A method for classifying data, comprising:
analyzing first data files having a higher usage than second data files, comprising identifying file attribute sets that are common in said first data files;
building a decision tree classifier, comprising:
associating one of said file attribute sets with each of a plurality of tree nodes;
selecting a root tree node from said plurality of tree nodes; and
selecting one or more subsequent tree nodes from said plurality of tree nodes, wherein said selecting of said root tree node and said selecting of said one or more subsequent tree nodes are based on said file attribute sets that are common in said first data files; and
removing a selected tree node from said decision tree classifier and selecting an alternate tree node based on said file attribute sets that are common in said first data files when said selected tree node violates a constraint.

12. The method according to claim 11, wherein said analyzing said first data files further comprises associating associated qualifiers with each of said file attribute sets, wherein each of said associated qualifiers represents a corresponding one of said first data files.

13. The method according to claim 12, wherein said analyzing said first data files further comprises:
counting said associated qualifiers to determine a number of said associated qualifiers that are associated with each of said file attribute sets; and
sorting said file attribute sets in descending order based on said number of said associated qualifiers.

14. The method according to claim 13, wherein said counting and said sorting is initially performed on said file attribute sets having only a single file attribute.

15. The method according to claim 11, wherein said selecting of said root tree node comprises selecting a tree node associated with a file attribute set having a largest number of said associated qualifiers, and
wherein said selecting of said at least one subsequent tree nodes comprises selecting one or more of said tree nodes associated with file attribute sets having a next largest number of said associated qualifiers following said file attribute set having said largest number of said associated qualifiers.

16. The method according to claim 11, further comprising defining at least one said constraint, comprising at least one of:
defining a first constraint that prevents classification of at least one of said second data files as at least one of said first data files;
defining a second constraint that prevents classification of at least one of said first data files as at least one of said second data files;
defining a third constraint that prevents classification of a data file having a quantity of file attributes that is greater than a predetermined amount as one of said first data files; and
defining a fourth constraint that prevents classification of a data file having an associated file attribute set having a size that is greater than a predetermined size as one of said first data files.

17. A method of classifying files comprising:
dividing said first files into:
second files that have a usage above a predetermined value; and
third files that have a usage below said predetermined value;
identifying sets of attribute-value pair combinations comprising inherent attributes and respective attribute values for each of a plurality of said first files;
identifying distinguishing attribute-value pair combinations that are associated only with said second files and are not associated with said third files;
establishing a set of said distinguishing attribute-value pair combinations, wherein said set of said distinguishing attribute-value pair combinations has a maximum set size;
selecting fourth files as ones of said second files that:
have first distinguishing attribute-value pairs that are in said set of said distinguishing attribute-value pair combinations; and
have a number of attributes less that a predetermined attribute maximum, wherein said selecting of said fourth files is limited so as to produce maximum false-positives and maximum false-negatives; and
identifying said fourth files as most valuable files of said first files.

18. The method according to claim 17, wherein said maximum set size, said predetermined attribute maximum, said maximum false-positives, and said maximum false-negatives is established by a user.

19. The method according to claim 17, wherein said selecting of said fourth files further comprises executing a decision tree with back-tracking and tree pruning to maintain said fourth files within said maximum false-positives and said maximum false-negatives.

20. The method according to claim 17, wherein said establishing of said set of said distinguishing attribute-value pair combinations comprises selecting distinguishing attribute-value pair combinations that have the least amount of attributes over said distinguishing attribute-value pair combinations that have a greater amount of said attributes to maintain said set of said distinguishing attribute-value pair combinations within said maximum set size.
